(19) United States
(12) Patent Application Publication
(10) Pub. No.: US 2009/0092821 A1
(43) Pub. Date: Apr. 9, 2009

(54) FIBER-REINFORCED FOAMED RESIN STRUCTURAL COMPOSITE MATERIALS AND METHODS FOR PRODUCING COMPOSITE MATERIALS

(76) Inventor: C.K. Hari Dharan, Berkeley, CA (US)

Correspondence Address: STEVEN VOSEN, 1563 SOLANO AVENUE #206, BERKELEY, CA, 94707, US

(21) Appl. No.: 12/246,391

(22) Filed: Oct. 6, 2008

Related U.S. Application Data
(60) Provisional application No. 60/978,532, filed on Oct. 9, 2007.

(51) Int. Cl. B32B 3/26; B29C 44/12

(52) U.S. Cl. 428/314.4; 264/46.6; 264/46.5; 264/45.3; 428/319.9

(57) ABSTRACT

A method of continuously producing fiber-reinforced foamed resin structural composite materials is described. One embodiment of the method includes providing a foamable resin between fiber-reinforced layers within a cooled die. Another embodiment of the method includes providing elements through a fiber-reinforced foamed resin composite material for communicating information and/or fluids. Thus, for example, optical fibers, electrical conductors, or water or air ducts may be included through the composite material. The material is inexpensive to produce and can be recycled.

### CROSS-REFERENCE TO RELATED APPLICATIONS

This application claims the benefit of U.S. Provisional Application No. 60/978,532, filed Oct. 9, 2007. The entire contents of the above-listed provisional application are hereby incorporated by reference herein and made part of this specification.

### BACKGROUND OF THE INVENTION

1. Field of the Invention

The present invention generally relates to fiber-reinforced foamed resin composite materials and method of producing such materials, and more particularly to fiber-reinforced foamed resin composite materials that can be formed continuously and their production methods.

2. Discussion of the Background

Many synthetic materials have been proposed to replace wood and other structural materials. Synthetic lumber made from wood fiber waste and thermoplastics such as polyethylene can be produced at reasonably low cost and has been used to replace wood decking and fence posts. However, such wood replacements are not as stiff or as strong as wood. In general, it has been difficult to develop composite building materials having both adequate properties and low cost. In addition, traditional synthetic building materials are not generally environmentally friendly in that they cannot be recycled and cannot be made of recycled materials.

There is a need in the art for a composite material that possesses a high flexural modulus, high strength and low density, and that can be configured to meet specific applications. There is also a need for a composite material that can be manufactured at low cost, that can be made with recycled material, and that can itself be recycled.

### BRIEF SUMMARY OF THE INVENTION

The present invention overcomes the disadvantages of prior art by providing fiber-reinforced foamed resin composite materials that can be formed continuously. The methods includes the ability to produce composite materials having many useful properties including, but not limited to, the ability to be nailed and cut like wood, and the ability to be ballistic resistant, if required. In one embodiment, the material has a combination of tailored high-strength oriented fibers and a tailored matrix that allows for the production of material with a variety of composite properties.

In certain embodiments, a composite material is provided. The material includes a foam and one or more fiber-reinforced layers, where the fiber-reinforced layer includes a thermoplastic matrix having embedded fibers having a fiber length greater than 0.05 meter.

In certain other embodiments, a composite material is provided. The material includes a foam and one or more fiber-reinforced layers, where said material has a Young's modulus of from 8-20 GPa.

In another other embodiment, a composite material is provided. The material includes a foam and one or more fiber-reinforced layers, where said fiber-reinforced layer includes a thermoplastic matrix, where said material has a density of from 200 to 1000 kg/m³.

In yet another other embodiment, a composite material is provided. The material includes a foam and one or more fiber-reinforced layers, where said fiber-reinforced layer includes a thermoplastic matrix, a foam and one or more fiber-reinforced layers. The foam is a closed-cell foam, and where said closed-cell foams include a non-gaseous fluid.

In certain embodiments, a method of producing a fiber-reinforced foamed composite material is provided. The method includes translating two layers through a heated device, where each of the two layers includes a fiber-reinforced thermoplastic resin; supplying a foamable resin between the two layers; foaming the foamable resin in the heated device; and bonding the two layers to the foamable resin. In one embodiment, where each of the two layers includes fibers substantially aligned in a fiber specifically oriented in a direction relative to the direction of translating.

In certain other embodiments, a method of producing a composite material is provided. The method includes continuously forming a fiber-reinforced foamed composite material having embedded elements for conducting information or fluids. In one embodiment, the elements include optical fibers. In another embodiment, the elements include electrical conductors. In yet another embodiment, the elements include a passageway. In one embodiment, the method includes foaming a foamable resin between a pair of fiber reinforced layers, where the elements are embedded in the resin.

In certain embodiments, a method of producing a composite material is provided. The method includes translating two layers through a heated device, where each of the two layers includes a fiber-reinforced thermoplastic resin; supplying a foamable resin between the two layers; foaming the foamable resin in the heated device; bonding the two layers to the foamable resin; and providing elements for conducting information or fluids within the composite material. In one embodiment, the elements include optical fibers. In another embodiment, the elements include electrical conductors. In yet another embodiment, the elements include a passageway. In one embodiment, the method includes foaming a foamable resin between a pair of fiber reinforced layers, where the elements are embedded in the resin.

These features together with the various ancillary provisions and features which will become apparent to those skilled in the art from the following detailed description, are attained by the method of producing a composite material of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a schematic of one embodiment of an apparatus that may be used to perform one embodiment of a method of producing a fiber-reinforced layer;

FIGS. 2A, 2B, and 2C show three consecutive views of one embodiment of a process of producing a roll having non-longitudinal fiber alignment;

FIG. 3 is a schematic of one embodiment of an apparatus that may be used to perform one embodiment of a method of producing composite material using the a fiber-reinforced layer;

FIG. 4A is a sectional longitudinal side view of a first embodiment of a foaming die;

FIG. 4B as a sectional longitudinal side view of second embodiment of a die body;

FIG. 5A is an end view 5-5 of FIG. 4A;

FIG. 5B is a sectional end view 5B-5B of a first alternative embodiment of the die of FIG. 4A;

FIG. 5C is a sectional end view 5C-5C of a second alternative embodiment of the die of FIG. 4A;

FIG. 6 is a cross-sectional view 6-6 of FIG. 3 of a first embodiment of a composite material;

FIG. 7A is a cross-sectional view, FIG. 7B is a side view, and FIG. 7C is a top view of a second embodiment of a composite material;

FIG. 8 is a cross-sectional view of a third embodiment of a composite material formed by providing texture to the outer surfaces; and

FIG. 9 is a cross-sectional view of a fourth embodiment of a composite material having a pair of foamed layers and a central fiber reinforced layer.

Reference symbols are used in the Figures to indicate certain components, aspects or features shown therein, with reference symbols common to more than one Figure indicating like components, aspects or features shown therein.

### DETAILED DESCRIPTION OF THE INVENTION

Certain embodiments presented herein include fiber-reinforced foamed resin composite materials and methods for producing such materials. Thus, for example, one embodiment includes a pultrusion-like process to form fiber-reinforced layers. Another embodiment includes an extrusion-like process to produce foamed resin layers. Yet another embodiment includes bonding the fiber-reinforced layers and the foamed resin layers into a composite material a continuous manner.

In general, materials and methods are provided to engineer fiber-reinforced foamed resin composite materials properties according to the volume fractions of the composite material constituents. By varying the physical location of each of the components with respect to each other, an additional range of desired properties is achieved. For example, in structural applications requiring high bending stiffness at low cost and density, a structurally anisotropic component (such as glass, aramid or carbon fiber, for example) can be configured to be located at the extremes of the cross-section of the beam. At the same time, if desired, an optical fiber signal carrier (also an anisotropic component) may be located at the neutral-axis of the beam cross-section where it is not subjected to the bending loads experienced by the beam. Alternatively, the structural properties of wood may be mimiced by the selection of a a foamed cellular matrix mimicking the cellular microstructure of wood combined with a number of reinforcing fiber bundles that are distributed through the cross-section of the material.

Fiber-reinforced composite materials thus formed may have a variety of shapes and properties. Thus, for example and without limitation, the fiber-reinforced layers are anisotropic components and the foamed resin layers are isotropic components of the composite material. These components may have structural characteristics, including but not limited to a modulus of elasticity and weight that result in advantageous structural properties, resulting, for example, in a strong lightweight material that exhibits a hierarchical structure that is biomimetic or similar to that observed in natural structural biological materials such as bone and wood. The composite materials of the present invention can also be optimized for bending applications such as beams with a pair of fiber-reinforced layers located at the surfaces of the beam with fibers oriented along the beam axis, and a foamed resin core.

As one example of a method of forming a fiber-reinforced layer, which is provided without limitation, one or more fibers bundles are drawn, with fibers aligned, over a series of rollers or circular rods that are immersed in a resin bath (molten resin for thermoplastics, or catalyzed resin for thermosets). After immersing the fibers, any excess resin is removed, and the fibers and remaining resin are cooled (for thermoplastics) or cured (for thermosets) to form a continuous fiber-reinforced layer.

Alternatively, recycled materials may incorporated into fiber-reinforced foamed resin composite materials as filler. As an example, used fiber-reinforced foamed resin composite material may be recycled back into the foamable mixture of a new composite material.

In an alternative embodiment, the fiber-reinforced layer is further processed to change the surface or textures of the material. Thus, for example, a pattern of grooves, which may be transverse, longitudinal or angled with respect to the layer, may be formed into the surface of the fiber-reinforced layer by using appropriately shaped rollers on the layer before the resin hardens.

In another embodiment, one or more elements are embedded in and pass through the fiber-reinforced layer. Such elements include, but are not limited to, conduits, tubing, electrical conductors, thermal resistor elements, electronic circuits and components, optical fibers, or other components for conducting air, fluid, heat, or signals through the composite material and are provided along with the fiber-reinforced layer as it is being processed.

In one embodiment, methods include heating the fiber-reinforced layer before contacting the foaming mixture to facilitate bonding. In another embodiment, methods include providing one or more elements that are embedded in and pass through the composite material. Such elements include, but are not limited to, conduits, tubing, electrical conductor, thermal resistor elements, electronic circuits and components, optical fibers, or other components for conducting gas, fluid, heat or signals through the composite material are provided into the foaming die as the foamable agent expands to embed the elements.

In yet another alternative embodiments, methods include providing additional materials during the forming of one or more of the fiber-reinforced layer or the foamed resin layer. The additional materials may include, but are not limited to, small elements such as structural fibers, particles, gas-filled microballoons (foam), polymers, and metals.

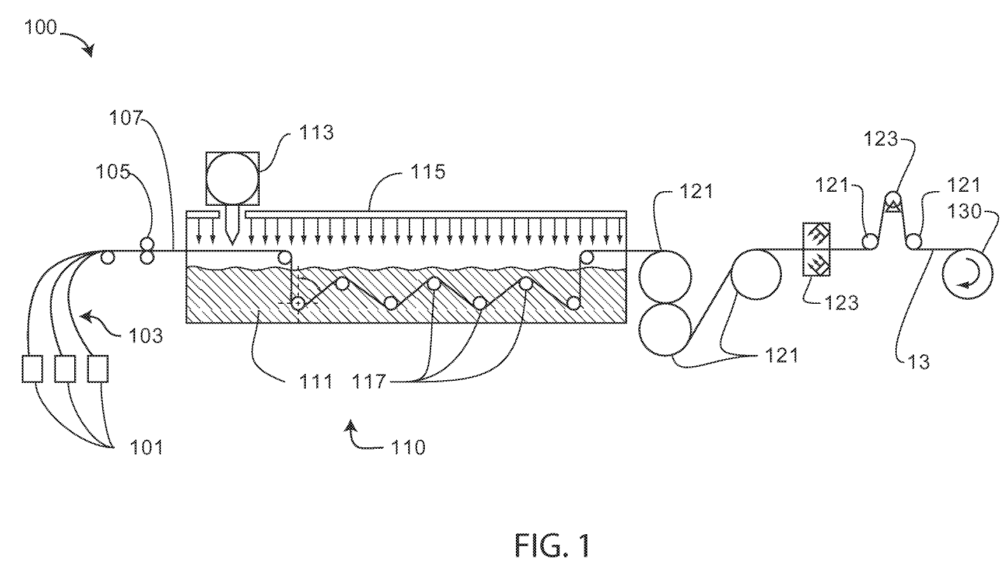

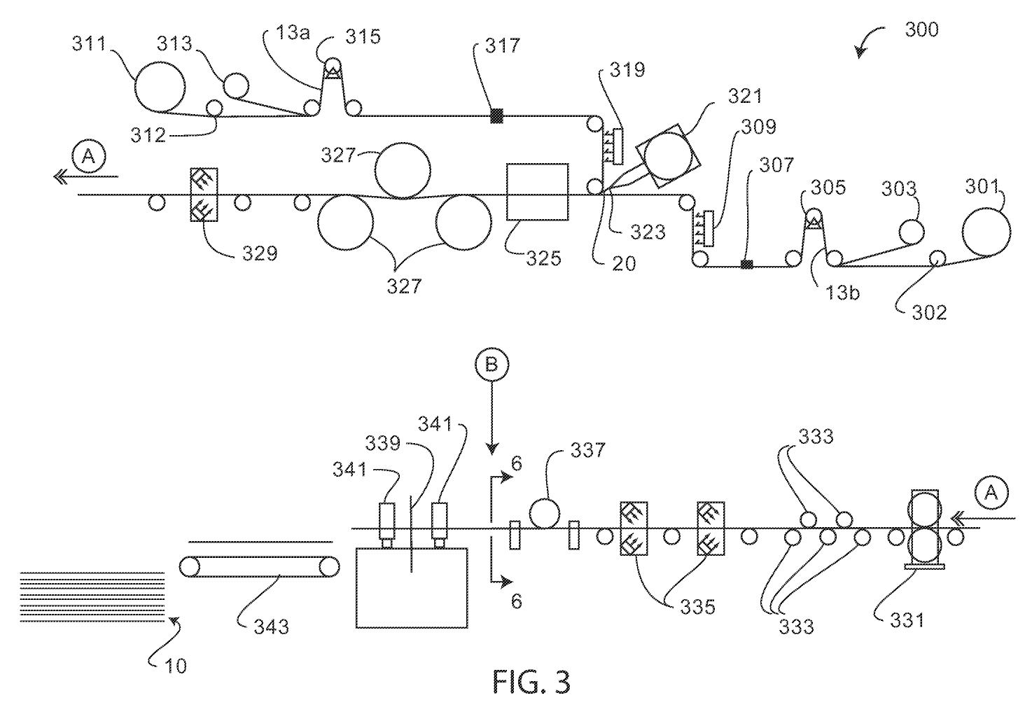

FIG. 1 is a schematic of one embodiment of an apparatus 100 that may be used perform one embodiment of a method of producing a fiber-reinforced layer, and FIG. 3 is a schematic of one embodiment of an apparatus 300 that may be used perform a method of producing composite material using a fiber-reinforced layer, as for example and without limitation, the layer produced by apparatus 100 combined with a foaming mixture. Neither the apparatus nor the methods described herein are meant to limit the scope of the present invention.

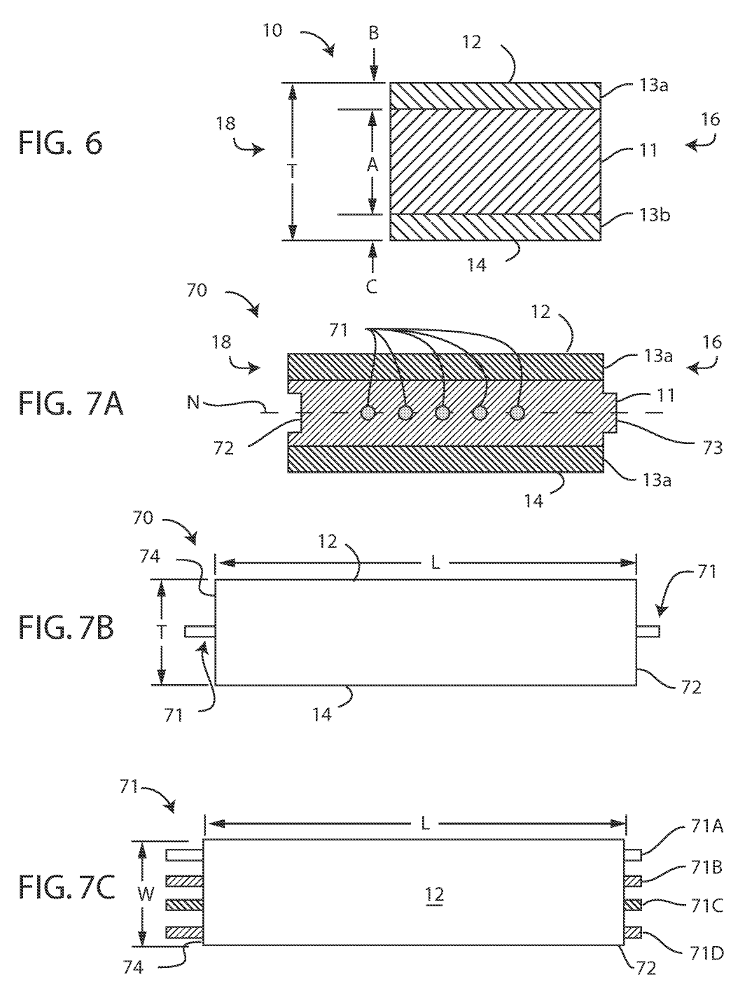

The discussion of the method embodied in apparatus 100 and 300 may be made clearer with reference to a cross-sectional view of a final composite product. Accordingly, FIG. 6 is provided herein as an example, without limitation, of a cross-sectional view 6-6 of FIG. 3 of a first embodiment of a composite material 10.

Composite material 10 has a thickness T formed from three substantially planar components: a core layer 11 having a thickness A and a pair of skin layers 13a and 13b, having thicknesses B and C, respectively. In one embodiment, core layer 11 is a foamed, isotropic layer, and skin layers 13a and 13b are fiber-reinforced, anisotropic, layers, where each layer has been described above. Core layer 11 may include an open or closed cell foam. If the foam is closed cell, then a fluid may be incorporated into the cell structure. Composite material 10 is further shown as having two opposing surfaces 12 and 14, where surface 12 includes a portion of layer 13a and surface 14 includes a portion of layer 13b, and edges 16 and 18. In one embodiment, skin layers 13a and 13b include fibers that are aligned perpendicular to thickness T (that is, aligned within the skin), and are bonded to core layer 11, which is a light-weight foam. In certain embodiments, one or more of surfaces 12 and 14 has a metallized or screen printed foils be bonded thereto, forming various finishes, such as a wood finish.

The methods allow for a wide range of dimensions of a composite material. The thickness T is selected to produce a composite material of certain dimensions or having certain physical properties. In various embodiments, the composite material has a thickness T of from ½ inch to 6 inches thick, and can be, without limitation, approximately ½ inch thick, approximately 1 inch thick, approximately 1½ inches thick, approximately 2 inches thick, approximately 3 inches thick, approximately 4 inches thick, or approximately 5 inches thick. The thickness C of the fiber-reinforced layer can be up to several millimeters thick, and can be, for example and without limitation, ½ millimeter or 1 millimeter thick. The width of the composite material is can be up to several feet, for example, and without limitation, 1 foot, 3 feet, or 8 feet. Almost any length of composite material can be formed from the continuous process.

Apparatus 100 includes tension rolls 103, an extruder 113, a heated impregnation stage 110, cooling rolls 121, an air cooling unit 123, a tension control stage including rolls 125 coupled to a tension transducer 127, and a wind-up roll 130. Heated impregnation stage 110 includes a heater 115, impregnation rolls 117, and a bath 111 of impregnation material.

Apparatus 100 accepts fibers 103 from several rolls 101. Fibers 103 may include, but are not specifically limited to, any fibers usable as reinforcing fibers and include, but are not limited to, inorganic fibers, such as glass fibers, carbon fibers and metal fibers; synthetic fibers, such as aramide fibers and rod polymer fibers; and natural fibers, such as silk, cotton and linen. The fibers may consist of ropes of nanofibers such as carbon nanotubes or zinc oxide nanowires.

In one embodiment, the fibers are formed in a continuous process with fiber diameters ranging from 0.1 micrometers to 125 micrometers. In various other embodiments, the fibers include segments of fibers, where at least one fiber is longer than 0.01 meter, is longer than 0.02 meter, is longer than 0.03 meter, is longer than 0.04 meter, is longer than 0.05 meter, is longer than 0.06 meter, is longer than 0.07 meter, is longer than 0.08 meter, is longer than 0.09 meter, or is longer than 0.1 meter. Alternatively, at least one fiber is longer than 0.15 meter, is longer than 0.2 meter, is longer than 0.25 meter, is longer than 0.3 meter, is longer than 0.35 meter, is longer than 0.4 meter, is longer than 0.45 meter, is longer than 0.5 meter, is longer than 0.6 meter, is longer than 0.7 meter, is longer than 0.8 meter, is longer than 0.9 meter, or is longer than 1 meter. In another embodiment, the fibers are longer than 0.10 meter.

The resin used in the fiber-reinforced layers may include a thermoplastic or thermoset resin. The thermoplastic resin may include, but is not specifically limited to, one or more of polyvinyl chloride, chlorinated polyvinyl chloride, vinyl chloride-vinyl acetate copolymer, vinyl chloride-acrylic acid copolymer, polyethylene, polypropylene, polystyrene, polyamide, polycarbonate, polyphenylene sulfide, polysulfone, polyetheretherketone, polyethylene terethalate and other thermoplastic polymers, polyglycolic acid, polycaprolactone, polylactic acid and other biodegradable polymers, polymethyl methacrylate, and thermoplastic elastomers such as ethylene vinyl acetate. The thermoplastic resin may also include a copolymer, a modified resin and/or a blend resin containing the above thermoplastic resin as a main component. Optionally, the resin may include one or more of an additive, a filler, such as reinforcing short fibers, glass microballoons, fly ash or tire rubber, a processing aid, or a modifier, such as a heat stabilizer, plasticizer, lubricant, antioxidant, ultraviolet absorber, or pigment. The thermoset resin includes catalyzed resins including, but not specifically limited to: epoxies, polyesters, vinyl esters, cyanate esters, crosslinked elastomers such as tire rubber, silicones and polyurethanes.

Fibers 103 then pass through tension rolls 105, and 121, which, according to feedback from tension transducer 123, maintain tension of the fibers as they progress through apparatus 100. The desired tension depends on the type and number of fibers being drawn through the apparatus 100 and is to be high enough to facilitate impregnation in the heated impregnation stage 110. As one example, a bundle of 2400 TEX glass fibers was tensioned to a tension of 25 lbs (110 N). Fibers 103 are then heated by heater 115 while a thermoplastic resin is fed through extruder 113 and over the fibers, into the impregnation bath 111. Fibers 103 and bath 111 are further heated while being moved through the melt by impregnation rolls 117. Heater 115 is sized to heat bath 111 to a molten state such that the viscosity of the resin is low enough to adequately wet the fibers. After leaving heated impregnation stage 110, the impregnated fibers are moved through cooling roll 121 and air cooling unit 123, cooling the resin to a hardened state and forming a fiber-reinforced layer 13, which passes though tension transducer 123 and onto wind-up roll 130. In one example, a temperature of 195 C was adequate for satisfactorily impregnating a bundle of 2400 TEX glass fibers with polypropylene resin.

Fiber-reinforced layers 13, in certain embodiments, are “fibrous,”—that is, the layers contain fibers that are piled or assembled together into a sheet form. It is preferred that, when forming the fiber-reinforced layer, the fibers be sufficiently spaced apart to provide adequate wetting by the resin. Specifically, there is a balance between having too few fibers, leading to lower structural properties in the composite material, and too many fibers, wherein the resin may not wet the fibers adequately leading to voids that may diminish the strength of the composite. In one embodiment, the fibers are arranged so that a cross-sectional area containing the fibers has a volume percent that are voids that range from 0.5 to 93 volume percent.

In an alternative embodiment, foils are bonded to one side of fiber-reinforced layer 13 prior to being wound onto roll 130. Such processes are commonly used in making flooring boards or laminated particle boards for furniture. The foil may then be located on the outer surface of a composite material, such as on a surface 12 or 14 of a composite material 10 as shown for example and without limitation in any one of FIGS. 6, 7A-C, 8, or 9.

In another alternative embodiment, elements such as optical fibers, electrical conductors, microwave waveguides, fluid transport channels, heating elements, electronic circuits and components, are embedded within layer 13, as shown for example and without limitation in FIG. 9, by feeding the elements with fibers 103 into impregnation stage 1 10. Preferably the elements so embedded are those that can sustain the temperature and stress of stage 110. In yet another alternative embodiment, RFID tags, sensors, actuators or other embedded transducers, such as load or displacement sensors, or accelerometers or other devices are fed into impregnation stage 110 to embed those elements within layer 13.

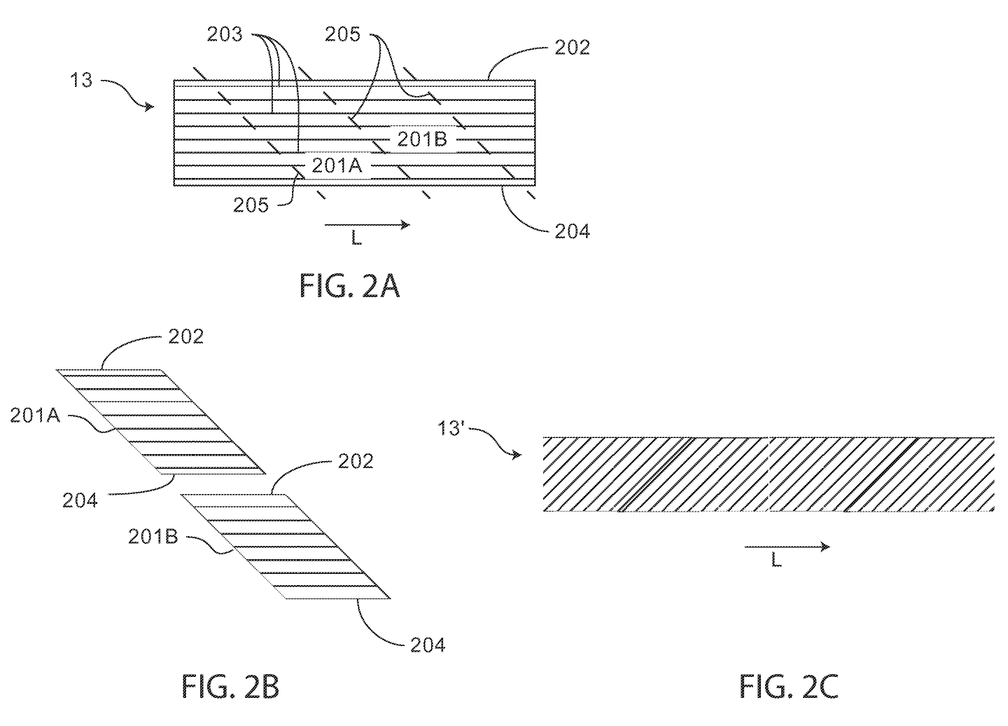

In an alternative embodiment, layer 13 is further processed to change the orientation of the fibers 103. In one embodiment, the material of roll 130 is sliced, rotated, rejoined, and re-rolled to form a roll having fibers that are not oriented along the length of the roll. Thus, for example, FIGS. 2A, 2B, and 2C show three consecutive views of one embodiment of a process of producing a roll having non-longitudinal fiber alignment. In FIG. 2A, a length of material 13 is shown as having edges 202 and 204 and fibers 203 each aligned in the direction of the length L of the material. Material 13 may be cut, as shown by cut lines 205, with a saw at an angle to the length L to produce portions 201A and 201B. As shown in FIG. 2B, portions 201A and 201B may be arranged with edges 202 and 204 abutting, and the portions may then be joined. Portions 201A and 201B may be joined, for example by ultrasonic bonding or roll bonding. The cutting and joining may be repeated, and any edges trimmed to form a layer 13′ having fibers that are not aligned with the length L, as shown in FIG. 2C. While FIGS. 2A-2C illustrate an approximately 45 degree fiber orientation, the method of FIG. 2A-2C provides for any orientation according to the angle and length L that cut 205 makes with the fibers.

Apparatus 300 includes primary rolls 301 and 311, rollers 302 and 312, secondary rolls 303 and 313, rollers having tension transducers 305 and 315, deflection transducers 307 and 317, preheaters 309 and 319, an extruder 321 with an output 323, a water-cooled foaming die 325, cooling rolls 327, a cooling unit 329, pull rolls 331, finishing rolls 333, a cooling unit 335, an edge trimming saw 337, clamps 341, a flying cut-off saw 339, and a conveyer 343. Rolls 301, 303, 311, and 313 include fiber-reinforced layers that may be the material of layer 13 or 13′. Apparatus 300 provides two layers 13 to a composite material, indicated as layer 13a and 13b.

The material of layer 13a is provided from primary roll 311, guided by roller 312, or from secondary roll 313, through rollers having tension transducer 315. Primary roll 311 and secondary roll 313 may be alternated to ensure a continuous supply of material for processing. The material is pulled past deflection transducer 317, and through preheater 319. Feedback between the rollers coupled to tension transducer 315 and deflection transducer 317 maintain the proper tension in the material of layer 13a. Likewise, the material of layer 13b is provided from primary roll 301, guided by roller 302, or from roll 303, through rollers having tension transducer 305. Primary roll 301 and secondary roll 303 may be alternated to ensure a continuous supply of material. The material is pulled past deflection transducer 307, and through preheater 309. Feedback between the rollers having tension transducer 305 and deflection transducer 307 maintain the proper tension in the material of layer 13b.

The preheated materials of layers 13a and 13b are heated to facilitate or initiate foaming of the foamable mixture. Foamable mixture 20, as describe subsequently, is provided by an extruder 321 between layers 13a and 13b and are guided by a water-cooled foaming die 325. In one embodiment, foamable mixture 20 is provided in an unfoamed state, and is prepared by kneading or permeating a blowing agent into a molten thermoplastic resin at a temperature lower than a foaming temperature of the blowing agent.

In another embodiment, foamable mixture 20 include, but are not necessarily limited to, a foamable mixture including a foamable resin and a blowing agent (which is also referred to as a foaming agent). In one embodiment, the foamable resin is a thermoplastic polymer, which may be, but is not limited to, polyvinyl chloride, chlorinated polyvinyl chloride, polyethyleneterethalate, polypropylene or polyethylene. In one embodiment, the foamable mixture and fiber-reinforced layers are fed into a die, which may be heated and/or cooled. The geometry of the composite material is maintained by the die as the foamable resin expands. The method may further include providing a force to pull the composite material through the manufacturing process line.

The blowing agent may include one or more of a physical blowing agent (a material that expands primarily due to pressure induced expansion or phase change) or a chemical blowing agent (a material that expands due to changes in species resulting from chemical reactions). Examples of chemical blowing agents include, but are not limited to, azodicarbonamide, azobisisobutyronitrile, N,N′-dinitropentamethylenetetramine, p,p′-oxybisbenzenesulfonylhydrazide, azodicarboxylic acid barium, trihydrazinotriazine and 5-phenyltetrazole, and sodium bicarbonate. Examples of a physical blowing agent include, but are not limited to, an aliphatic hydrocarbon, such as isopentane, heptane and cyclohexane; or an aliphatic hydrocarbon fluoride, such as trichlorotrifluoroethane and dichlorotetrafluoroethane. In addition, a gas may be provided as a physical blowing agent. Examples of gases as blowing agents include, but are not limited to, air, nitrogen, carbon dioxide, and helium. In one embodiment, the foaming mixture is premixed. In another embodiment, the foamable resin and blowing agent are provided separately into a die. Thus, for example, a foamable resin may be extruded into die and gaseous physical blowing agent maybe separately injected into the foamable resin.

The blowing agent is preferably mixed to foam in a range of 30 times or less, preferably between 1.5 and 5 times. As one example, on a weight basis, 1 to 20 parts of a liquid or solid blowing agent may be added per 100 parts of a thermoplastic resin.

For a chemical blowing agent, it is preferable to heat the blowing agent to near the decomposition temperature to have a high foaming rate without decomposition of the resin. For a physical blowing agent, it is required to heat the blowing agent above the boiling temperature. The term “foaming temperature” as used herein is a) the decomposition temperature of a chemical blowing agent, or b) a boiling temperature of a physical blowing agent. The term “decomposition temperature” as used herein is a temperature at which a decomposition degree is reduced to a half in three minutes.

After passing through die 325 the composite material is in a nearly formed state. The material is further cooled by cooling rolls 327 and air cooled by cooling unit 329 to solidify the composite material. The materials continue without interruption from (as indicated by the locations marked “A”) to pull rolls 331 which provide a longitudinal force on the composite material being formed. Finishing rolls 333 provide surface finishing to surfaces 12 and 14. The material is then cooled again by cooling unit 335. Next the edges are trimmed by edge trimming saw 337, forming surfaces 16 and 18. Clamps 341 then hold the material while a flying cut-off saw 339 cuts the material to size. A conveyer 343 then transports the individual composite material 10 for stacking.

In an alternative process, the process may stop at the location marked “B,” producing a supply of composite material of virtually any length.

In another alternative process, apparatus 100 and 300 are integrated by having two apparatus 100 that each feed layers 13 into apparatus 300, without the intermediate step of rolling layers 13.

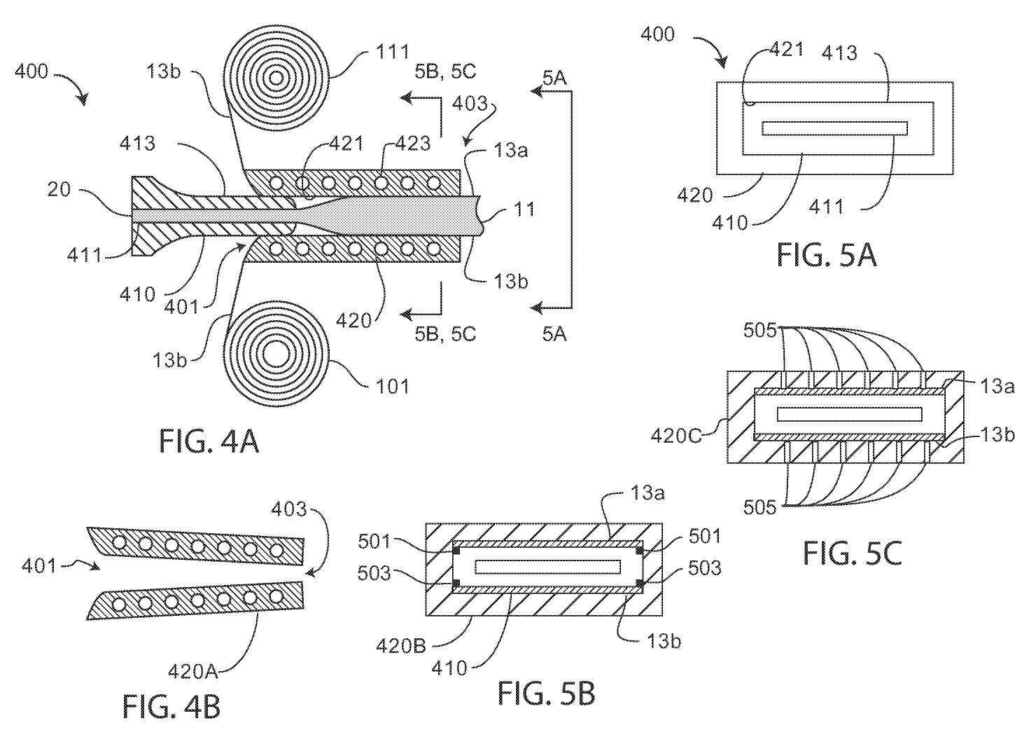

FIG. 4A is a sectional longitudinal view of a first embodiment of a foaming die 400 and FIG. 5A as an end view 5A-5A of FIG. 4A, which is generally similar to of water-cooled foaming die 325, except as explicitly stated.

Foaming die 400 includes an injector 410 and a die body 420. Injector has a bore 411 and a nozzle 413. Die body 420 has an input end 401 and output end 403, an inner surface 421 and water cooling channels 423. Bore 411 is connected to extruder output 323 and nozzle 413 is adjacent to inner surface 421. In one embodiment, the inside surfaces of the die, including but not limited to inner surface 421, is Teflon™ coated to minimize adhesion of the foam to the die.

The material of layers 13a and 13b pass between nozzle 413 and inner surface 421, and extruder output 323 provides material 401 which is injected between the material of layers 13a and 13b. As extruded foamable mixture 20 and the materials of layers 13a and 13b move through foaming die 400, the foamable mixture foams and is cooled by die body 420. The foam fills the entire space between and bonds with the materials of layers 13a and 13b and forms the material of layer 11.

FIG. 4B is a sectional longitudinal side view of second embodiment of a die body 420A, which is generally similar to die body 420. Die body 420A is tapered from a large opening at input end 401 to a smaller output end 403, such that the separation decreases as the foam moves through the die. In one embodiment, the taper angle was 5 degrees with respect to the axis of the die body.

FIG. 5B is a sectional end view 5B-5B of FIG. 4A, illustrating a first alternative embodiment of the die 420B. Die 420B, which is generally similar to die 420, has a first pair of guides 501 and a second pair of guides 503. First pair of guides 501 is adapted to hold the edges of layer 13a against the inner surface of die 420B and second pair of guides 503 is adapted to hold the edges of layer 13b against the inner surface of 420B. Guides 501 and 503 hold layers 13a and 13b while foaming material 20 expands and bonds with the layers.

FIG. 5C is a sectional end view 5C-5C of FIG. 4A illustrating a second alternative embodiment of die 420C, which is generally similar to die 420. Die 420C has a plurality of holes 505 that are each attached to a vacuum source. The vacuum holds layers 13a and 13b against the inner surface of die 420C while foaming material 20 expands and bonds with the layers.

As one example of producing a composite material 10, which is not meant to limit the scope of the present invention, layers 13a and 13b may be formed from a polypropylene resin and a 60% by volume glass fiber. Thus, for example, to match the properties of 1×6 oak board, 2400 TEX glass fiber roving at 2 mm spacing may be used. At 60% volume fraction of the glass fiber, the composite skin would be 0.75 mm thick. The glass fibers should have a thermoplastic-compatible size for good bonding to polypropylene.

As one example of a method of producing composite material 10, which is not meant to limit the scope of the present invention, core layer 11 may be formed from a foamable mixture 20 of polypropylene and 1% by weight of a chemical blowing agent such as azodicarbonamide plus 0.5% by weight of a rubber such as EVA (ethylene vinyl acetate) to facilitate foaming. In one embodiment, layers 13a and 13b are preheated to 160 C. Other additives that are application specific that may need to be added to the mix including, but not limited to, a flame retardant, a UV stabilizer, and/or colorants (dyes or pigments).

Composite material 10 is shown as being generally planar and may be, for example and without limitation, a building material such as a board or a plank, or a pallet. For illustrative purposes, FIG. 1 shows composite material 10 has having a length T and generally rectangular cross-sectional shape with a width W and a length L. Alternatively, composite material 10 may be curved in one or more directions, may have a cross-section that is not substantially rectangular, such as a circle, oval, square, or may have a cross-section that varies along length L.

FIGS. 7A-C, 8 and 9 illustrate second, third, and fourth embodiments of composite materials 70, 80, and 90, respectively, which are each generally similar to, and produced as described above, with reference to composite material 10, except as further detailed below. Where possible, similar elements are identified with identical reference numerals.

Another alternative embodiment of composite material and a method is shown with reference to composite material 70 in FIGS. 7A, 7B, and 7C, where FIG. 7A is a cross-sectional view, FIG. 7B is a side view and FIG. 7C is a top view of the composite material.

In one embodiment of a method of producing composite material 70, elements 71 are fed into die 325 between layers 13a and 13b. Foaming material 20 then expands to embed elements 71 within foam layer 11. Composite material 70 includes one or more elements 71 that extend through the composite material from a first face 72 to a second face 74. Although not limiting to the scope of the present invention, faces 72 and 74 are shown as being opposing faces separated by length L. Elements 71 include, but are not limited to, conduits, tubing, electrical conductor, thermal resistor elements, optical fibers, or other components for conducting air, fluid, or signals through composite material 70.

In general, element 71 may include several different types of elements, indicated as elements 71A, 71B, 71C, and 71D. Thus for example and without limitation, element 71A is a hollow conduit for transporting conditioned air, element 71B is an optical fiber bundle, element 71C includes electrical conductors, and element 71D is a hollow conduit for transporting water. Each one of elements 71 may include appropriate connectors at one or more of face 72 and 74 to continue the transport of fluids or signals into and away from composite material 70.

For elements that are susceptible to damage from bending stresses, it is preferred, though not required that a substantial portion of elements 71 be located at the neutral-axis of the cross-section of composite material 70 so that it not be subjected to the bending loads.

For elements 71 that are optical fibers or electrical conductors, connectors may be provided to the elements on faces 72 and 74. For electrical conductors, typical wood or plastic screws may be driven into the layers near the conductors. For optical fibers, a tool would be used to pull the end of the optical fiber from the composite material, and the free end would then be spliced using conventional optical fiber connectors.

Composite material 70 also includes a pair of matching groove 72 and tongue 74 which may be cut into the material by edge trimming saw 337. Groove 72 and tongue 74 permit composite material 70 to be stacked side-by-side to form a surface. In one embodiment, groove 72 and tongue 74 match the grooves and tongues in standard construction products to permit composite material 70 to be interchanged with other planks.

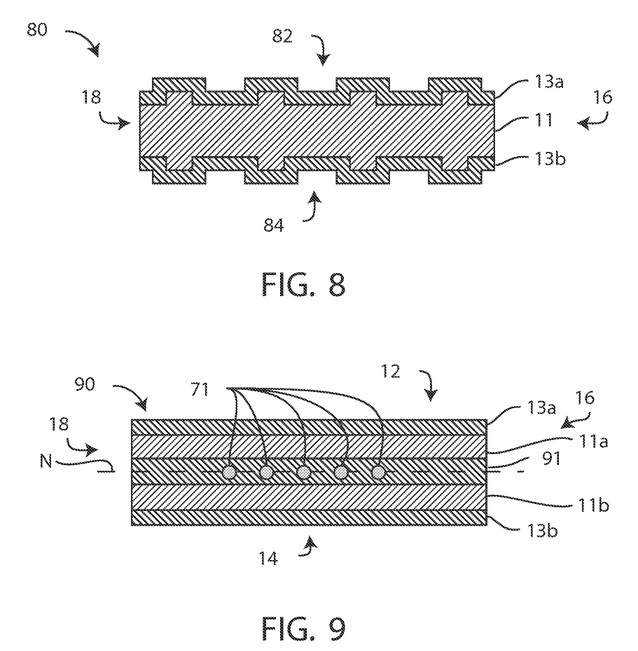

In an alternative embodiment, fiber-reinforced layer 13 may be further processed to change the surface or textures of the material. FIG. 8 is a cross-sectional view of composite material 80 formed by providing texture to surfaces 82 and 84 of fiber-reinforced layers 13a and 13b, respectively. In one embodiment, a pattern of grooves, which may be transverse, longitudinal or angled with respect to the layer, may be formed into the surface of layers 13a and/or 13b by appropriately shaped impregnation rollers 117. The modified layers 13a and 13b may then be provided to apparatus 300 to form composite material 80.

In another alternative embodiment, a central fiber-reinforced layer is provided. FIG. 9 is a cross-sectional view of an embodiment of a composite material 90, having a pair of foamed layers 11a and 11b and a central fiber reinforced layer 91. Layer 91 is formed by feeding elements 71 into impregnation stage 110 along with fibers 803. Composite material 90 is then formed in an apparatus having an additional fiber-reinforced layer system that inserts layer 91 between layers 13a and 13b into a die and extrudes one foaming mixture 20 between layer 13a and layer 91 and a second foaming layer between layer 91 and layer 13b. Layers 13a, 13b, and 91 may or may not require heating depending upon their thickness, with a thick sheet requiring surface heating before it enters the foaming die, and on the temperature of the foaming polymer.

In yet another embodiment, core layer 11 is a closed cell foam that incorporates a fluid within the cells. Thus, for example and without limitation, a fluid can be incorporated into the polymer core by emulsifying the fluid with the molten polymer at elevated temperatures. Preferably the fluid and the molten polymer must be immiscible such that the fluid and molten polymer mixture form an emulsion. On cooling the emulsion, the polymer solidifies, encapsulating fluid zones within the polymer. In another embodiment, the melting point of the fluid is below room temperature (or the maximum service temperature) and the melting point of the polymer is above room temperature (or the maximum service temperature). Examples of fluids which may be incorporated into a closed cell foam layer 11 include, but are not limited to shear-thickening fluids, fluids with particle, such as gas-filled micropheres, or particles of specific thermal, electrical, or magnetic properites.

The selection of fluid properties results affects the properties of the resulting structure. Thus, for example, one embodiment incorporates, into the foam, a shear-thickening fluid (that is a non-newtoninan fluid having a viscosity that increases with the rate of shear). Examples of shear-thickening fluids include, but are not limited to, silica nanoparticles suspended in polyethylene glycol or similar non-volatile fluid. With such fluids incorporated into the closed cell foam, the structure may be able to resist lateral ballistic penetration of projectiles while, at the same time, accommodating structural loads such as bending, compression or tension. Such a structure would be expected to be useful for applications where ballistic resistance is important in addition to low mass. In another embodiment, an incorporated fluid within the closed cell foam contains particles, for example, gas-filled microspheres, whose presence provides a structure with tailored damping properties for sound absorption. In yet another embodiment, the encapsulated fluid incorporated in the foam contains particles, for example, ferromagnetic nanoparticles such as iron, resulting in a structure with certain desired magnetic and electromagnetic properties. In another embodiment, the fluid contains particles, for example, electrical or thermally conductive particles such as silver, copper and/or graphite, resulting in a structure with certain desired electrical and thermal properties.

In other embodiments, fiber-reinforced foamed resin structural composites are engineered as a wood-substitute. Thus a wood-substitute composite may be formed having a foamed thermoplastic matrix that mimics the cellular nature of wood and longitudinal reinforcing fibers which simulate the grain of the wood. This new material can be designed to mimic the stiffness and strength of wood as well as its density while, at the same time, providing consistent and uniform properties characteristic of a synthetic material. As an example, by adjusting the loading of glass fibers and the amount of foaming, a wide range of mechanical properties may be obtained. In one embodiment, a wood-substitute composite has a Young's Modulus within the rage of from 8-20 GPa can be obtained, which includes the range of moduli for woods. Thus, for example and without limitation, the Young's Modulus is from 8-20 GPa, from 8-14 GPa, from 10-14 GPa, or is approximately 9 GPa, approximately 10 GPa, approximately 11 GPa, or approximately 12 GPa. A density of from 200 to 1000 kg/m³ can also be obtained, which includes the range of density of woods. Thus for example and without limitation, the density is from 200 to 1000 kg/m³, from 300 to 800 kg/m³, is approximately 300 kg/m³, approximately 400 kg/m³, approximately 500 kg/m³, approximately 600 kg/m³, approximately 700 kg/m³ or approximately 800 kg/m³.

In another embodiment, the wood-material consisting entirely of recyclable materials such as a thermoplastic matrix and glass fibers which can be chopped up and re-injection molded to make structural components suitable for automotive and industrial applications. The use of composite materials affords advantages to wood. Thus, for example, a fiber-reinforced foamed resin structural composite wood-substitute has the same stiffness, density and cost as wood but is also much stronger than wood—on the order of 6 times stronger. As a further example, the functionality of the wood-substitute is superior to wood, as the material may include signal conductors, RFID tags, sensors, and actuators, as described above.

Reference throughout this specification to “certain embodiments,” “one embodiment” or “an embodiment” means that a particular feature, structure or characteristic described in connection with the embodiment is included in at least one embodiment of the present invention. Thus, appearances of the phrases “in certain embodiments,” “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I claim:

1. A method of producing a fiber-reinforced foamed composite material, said method comprising:
translating two layers through a heated device, where each of said two layers includes a fiber-reinforced thermoplastic resin;
supplying a foamable resin between said two layers;
foaming said foamable resin in said heated device; and
bonding said two layers to the foamable resin.

2. The method of claim 1, where said fiber-reinforced thermoplastic resin includes a resin selected from the group consisting of polyvinyl chloride, polypropylene, polyethyleneterethalate and polyethylene.

3. The method of claim 1, where said supplying occurs while foaming.

4. The method of claim 1, where said heated device includes a die, and said method further comprises:
providing a separation between said two layers in said die.

5. The method of claim 4, where said supplying, said bonding, and said providing occurs within said heated device, and where said foamable resin foams and bonds said two layers to form a composite material having a foam core with a thickness of said separation.

6. The method of claim 1, where said supplying said foamable resin composition includes:
supplying a formulated thermoplastic resin in a molten state; and
supplying a blowing agent in said formulated thermoplastic resin.

7. The method of claim 1, where said foamable resin composition has a foaming temperature, and where said heated device heats said foamable resin composition to a temperature greater than said foaming temperature.

8. The method of claim 7 where said supplying said foamable resin composition includes supplying a gaseous blowing agent dissolved in said foamable resin at a high pressure from an extruder, where said foamable resin composition foams when exiting said extruder.

9. The method of claim 1, where the portion of said two layers facing each other is heated prior to supplying said foamable resin composition.

10. The method of claim 9, where said heated device heats the facing portions of said two layers to greater than the foaming temperature before said supplying, and where said supplying supplies said foamable resin composition in a molten state.

11. The method of claim 1, where said foamable resin composition has an expansion ration of from approximately 1.5 to approximately 5.0.

12. The method of claim 1, where said foamable resin composition includes at least one thermoplastic polymer.

13. The method of claim 12, where said at least one thermoplastic polymer is polyvinyl chloride, chlorinated polyvinyl chloride, or polyethylene.

14. The method of claim 1, further comprising providing elements for conducting information or fluids though said material.

15. The method of claim 14, where said elements include optical fibers.

16. The method of claim 14, where said elements include electrical conductors.

17. The method of claim 14, where said elements include a passageway.

18. The method of claim 14, where said elements include an RFID tag.

19. The method of claim 4, where said providing a separation between said two layers in said die includes providing a separation that decreases during said foaming.

20. The method of claim 1, where said supplying includes supplying a fluid and a foamable resin, where said fluid forms an emulsion with a fluid, and where said foaming foams closed cell foam incorporating said supplied fluid in the closed cells.

21. A method of producing a composite material, said method comprising:
continuously forming a fiber-reinforced foamed composite material having embedded elements for conducting information or fluids.

22. The method of claim 21, where said elements include optical fibers.

23. The method of claim 21, where said elements include electrical conductors.

24. The method of claim 21, where said elements include a passageway.

25. The method of claim 21, where said elements include an RFID tag.

26. The method of claim 21, where said method includes foaming a foamable resin between a pair of fiber reinforced layers, and where said elements are embedded in said resin.

27. The method of claim 21, where said method includes:
foaming a first foamable resin between a first fiber reinforced layer and a second fiber reinforced layer
foaming a second foamable resin between said second fiber reinforced layer and a third fiber reinforced layer,
where said elements are embedded in said second fiber reinforced layer.

28. A composite material comprising:
a foam and one or more fiber-reinforced layers, where said fiber-reinforced layer includes a thermoplastic matrix having embedded fibers having a fiber length greater than 0.05 meter.

29. The composite material of claim 28, where the fiber length is greater than 0.10 meter.

30. The composite material of claim 28, where the fiber length is greater than 0.20 meter.

31. The composite material of claim 28, where said material includes elements for fiber optic communications.

32. The composite material of claim 28, where said material includes wiring for electrical communications.

33. The composite material of claim 28, where said material includes RFID tags.

34. The composite material of claim 28, where said material includes sensors.

35. The composite material of claim 28, where said thermoplastic matrix is formed from a resin selected from the group consisting of polyvinyl chloride, polypropylene, polyethyleneterethalate and polyethylene.

36. A composite material comprising a foam and one or more fiber-reinforced layers, where said fiber-reinforced layer includes a thermoplastic matrix, where said material has a Youngs modulus of from 8-20 GPa.

37. The composite material of claim 36, where said thermoplastic matrix is formed from a resin selected from the group consisting of polyvinyl chloride, polypropylene, polyethyleneterethalate and polyethylene.

38. A composite material comprising a foam and one or more fiber-reinforced layers, where said fiber-reinforced layer includes a thermoplastic matrix, where said material has a density of from 200 to 1000 kg/m³.

39. The composite material of claim 38, where said thermoplastic matrix is formed from a resin selected from the group consisting of polyvinyl chloride, polypropylene, polyethyleneterethalate and polyethylene.

40. A composite material comprising a foam and one or more fiber-reinforced layers, where said foam is a closed-cell foam, and where said closed-cell foams include a non-gaseous fluid.

41. The composite material of claim 40, where said fiber-reinforced layer includes a thermoplastic matrix, where said thermoplastic matrix is formed from a resin selected from the group consisting of polyvinyl chloride, polypropylene, polyethyleneterethalate and polyethylene.
